(19) United States
(12) Patent Application Publication
(10) Pub. No.: US 2023/0354873 A1
(43) Pub. Date: Nov. 9, 2023

(54) LAYER-BY-LAYER PRODUCTION OF 3-D SUGAR-BASED FOOD PRODUCTS

(71) Applicant: Culinary Printworks, Inc., Ojai, CA (US)

(72) Inventors: Kayi Novissi Kristina Kouevi, Mannheim (DE); Ravi Shankar, Wilsonville, OR (US); Jule W. Thomas, Jr., West Linn, OR (US)

(21) Appl. No.: 17/913,785

(22) PCT Filed: Mar. 23, 2020
(86) PCT No.: PCT/US20/24330

§ 371 Date: Sep. 22, 2022

(51) Int. Cl. A23P 20/20; A23L 29/30; A23L 29/00; A23L 3/3517; A23L 5/42; A23L 29/10; B33Y 70/00; B33Y 80/00

(52) U.S. Cl. CPC A23P 20/20; A23L 29/37; A23L 29/035; A23L 3/3517; A23L 5/42; A23L 29/10; A23L 29/35; B33Y 70/00; B33Y 80/00; A23P 2020/253

(57) ABSTRACT

The invention relates to an aqueous binder liquid that can advantageously be used in the layer-by-layer production of 3-D sugar-based food products. More particularly, the invention relates to an aqueous binder liquid containing: (a) 50-70 wt. % water; (b) 12-30 wt. % sugar alcohol; (c) 5-20 wt. % short chain polyol selected from glycerol, propane-1, 2-diol and combinations thereof; and (d) 3-10 wt. % ethanol; wherein components (a), (b), (c) and (d) together constitute at least 90 wt. % of the aqueous binder liquid. The aqueous binder liquid of the present invention is particularly suitable for use in methods of layer-by-layer production of 3-D sugar-based food products in which the binder liquid is applied by means of piezo inkjet print heads. These methods enable the production of highly creative and complex patterns, such as cocktail toppers, edible logos and decorative wedding cake toppers. The invention further relates to a three-dimensional sugar-based food product that has been obtained by a layer-by-layer production method that employs the aforementioned aqueous binder liquid.

### TECHNICAL FIELD OF THE INVENTION

The present invention relates to the layer-by-layer production of three-dimensional (3-D) sugar-based food products.

One aspect of the invention relates to an aqueous binder liquid for use in the layer-by-layer production of 3-D sugar-based food products, said aqueous binder liquid containing:
(a) 50-70 wt. % water;
(b) 12-30 wt. % sugar alcohol;
(c) 5-20 wt. % short chain polyol selected from glycerol, propane-1,2-diol and combinations thereof; and
(d) 3-10 wt. % ethanol;
wherein components (a), (b), (c) and (d) together constitute at least 90 wt. % of the aqueous binder liquid.

The binder liquid of the present invention is particularly suitable for use in methods of layer-by-layer production of 3-D sugar-based food products in which the binder liquid is applied by means of piezo inkjet print heads.

Another aspect of the invention relates to a three-dimensional sugar-based food product that has been obtained by a method comprising:
(1) depositing a layer of sugar-containing powder;
(2) applying the aforementioned aqueous binder liquid onto the deposited layer in accordance with a predefined pattern to bond particles contained in the sugar-containing powder;
(3) repeating steps (1) and (2) at least 20 times; and
(4) separating the three-dimensional food product formed by the bonding from non-bonded powder.

### BACKGROUND OF THE INVENTION

3-D printing is a process whereby an object is built up layer-by-layer, form a 3-D computer design using printing technology. 3-D printing is used in the manufacturing industry to process plastics, ceramics and metals, but also in the production of food products. 3-D printing of food products can create unique product structures that other production methods cannot emulate.

Godoi et al. (3-D printing technologies applied for food design: Status and prospects, Journal of Food Engineering, (2016) 179, p. 44-54) classify the printing methods in 3-D food printing on the basis of the nature of the source material (liquid, powder or cells).

In the case of powder-based methods, for example sugar, cocoa powder or seasonings are used to create complex forms. The source material is first spread over a level surface which can be lowered. A heat source such as a laser or a hot air current serves to heat the particles of each layer along the coordinates briefly and thus melt them together at the appropriate places. The building platform is lowered by one layer thickness and a new set of powder material is then spread over the surface and again melted together at the predefined places. Alternatively, a liquid bonding agent (binder) can be used for this operation.

Unfortunately, due to their widely varying properties and the differences in resistance to heat and/or moisture, many foods are not suitable for 3-D food printing.

US 2003/0097949 describes an edible ink composition for use in a printing process, said ink composition comprising water, a pigment, a15-25 wt. % of a film former, 10-15 wt. % of an emulsifier, 0.5-5 wt. % of a humectant, and less than 1 wt. % of a non-aqueous drying agent, with the total of 100% by weight.

US 2005/255205 describes a food grade ink jet ink comprising a food grade pigment; a food grade lower alcohol; at least about 20 wt. % 1,2-propanediol; and a shellac; wherein the food grade ink has a viscosity of no more than about 100 cps at 25° C.

US 2008/0260918 describes a manufacturing method for three-dimensional food by rapid prototyping technology, comprising the steps of:
(1) confirming a customer requirement on a three-dimensional figure and a three-dimensional word character;
(2) inputting the customer requirement into a computer;
(3) dimensionizing and coloring graphic and text data processed by a 3-D post-processing software, and computing or processing the data;
(4) combining a final figure and converting the figure into a file with a STL format;
(5) sending a STL data to a rapid prototyping machine and preparing to start the manufacture;
(6) driving a nozzle to spray a binder rapidly back and forth by a rapid prototyping machine according to the graphic data sent from the slicing layer software, and manufacturing the three-dimensional food, and
(7) removing finished goods of the three-dimensional food from the rapid prototyping machine and carrying out a post processing.

US 2013/0034633 describes a method for making an edible component, comprising:
a. depositing a predetermined number of successive layers of a food material; and
b. applying to one or more predetermined regions of each successive layer of food material one or more edible binders that will cause the food material to become bonded at said one or more predetermined regions, the applying means applying said edible binders after each successive layer of food material has been deposited to form said edible component.

An exemplary recipe utilized rice wine (86.5% distilled water, 12% alcohol and 1.5% salt) as edible binder, and a food mixture containing 50% granulated sugar, 20% powdered sugar, 20% flour and 10% meringue powder (itself consisting of corn starch, egg whites, sugar, gum arabic, sodium aluminum sulfate, citric acid, cream of tartar and vanillin) as a printing substrate.

US 2017/0164650 describes a method for the production of an edible object, comprising providing an edible powder composition and at least one edible liquid, wherein the edible powder composition comprises a water soluble protein, a hydrocolloid and a plasticizer, and subjecting said composition to powder bed printing by depositing the edible liquid, e.g. water, onto the powder in layer-wise manner and thereby obtaining the edible object.

### SUMMARY OF THE INVENTION

The inventors have developed a method for the layer-by-layer production of 3-D sugar-based food products that enables the production of highly intricate structures. The method typically begins with the representation of a 3-D object using a computer-aided design (CAD) model or other digital data input. These digital geometry data are then converted into machine control and tool path commands that serve to drive and control a part-building tool that forms the object layer by layer.

The layer-by-layer production method of the present invention belongs to a class of 3-D printing systems that utilize translating powder bins and ink-jet binder liquid dispensers. A sugar-containing powder is deposited in sequential layers, each on top of the previous layer. Following the deposition of each layer of powder, a binder liquid is selectively applied, using an ink-jet printing technique or the like, to appropriate regions of the layer of sugar-containing powder in accordance with a sliced CAD model of the three-dimensional part to be formed. This binder application fuses the current cross-section of the part to previously bound cross-sections, and subsequent sequential application of powder layers and binder liquid complete the formation of the desired part

A crucial element of the production method of the present invention lies in the use of a suitable edible binder liquid to bind the particles within the sugar-containing powder using hydration-activated binding. In order to achieve hydration-activated binding, the binder liquid must be water-based. To function effectively, binder liquid that has been deposited onto the layer of sugar-containing powder needs to be able to penetrate the top layer of powder and sufficiently wet the next layer to ensure adhesion between layers. Rapid binding is desirable to increase the rate at which new layers can be deposited. Prior to printing, the binder liquid should be stable, easy to rehydrate, and slow to dry. After printing, the binder liquid should dehydrate quickly and rehydrate slowly. Finally, the binder liquid should not clog the printer nozzle and it should show minimum droplet spreading after application onto the sugar-containing powder.

The inventors have succeeded in developing a binder liquid that meets the aforementioned desiderata. The binder liquid according to the present invention is an aqueous liquid containing:
(a) 50-70 wt. % water;
(b) 12-30 wt. % sugar alcohol;
(c) 5-20 wt. % short chain polyol selected from glycerol, propane-1,2-diol and combinations thereof; and
(d) 3-10 wt. % ethanol;
   wherein components (a), (b), (c) and (d) together constitute at least 90 wt. % of the aqueous binder liquid.

The aqueous binder liquid of the present invention is particularly suitable for use in methods of layer-by-layer production of 3-D sugar-based food products in which the binder liquid is applied by means of piezo inkjet print heads. These methods enable the production of highly creative and complex patterns, such as cocktail toppers, edible logos and decorative wedding cake toppers.

Also provided is a kit comprising at least four sealed containers including a first container, a second container, a third container and a fourth container, wherein the binder liquid in the first container is colored red, the binder liquid in the second container is colored yellow, the binder liquid in the third container is colored blue and the binder in the fourth container is non-colored.

The invention further relates to a three-dimensional sugar-based food product that has been obtained by a method comprising:
(1) depositing a layer of sugar-containing powder;
(2) applying the aforementioned aqueous binder liquid onto the deposited layer in accordance with a predefined pattern to bond particles contained in the sugar-containing powder;
(3) repeating steps (1) and (2) at least 20 times; and
(4) separating the three-dimensional food product formed by the bonding from non-bonded powder.

### BRIEF DESCRIPTION

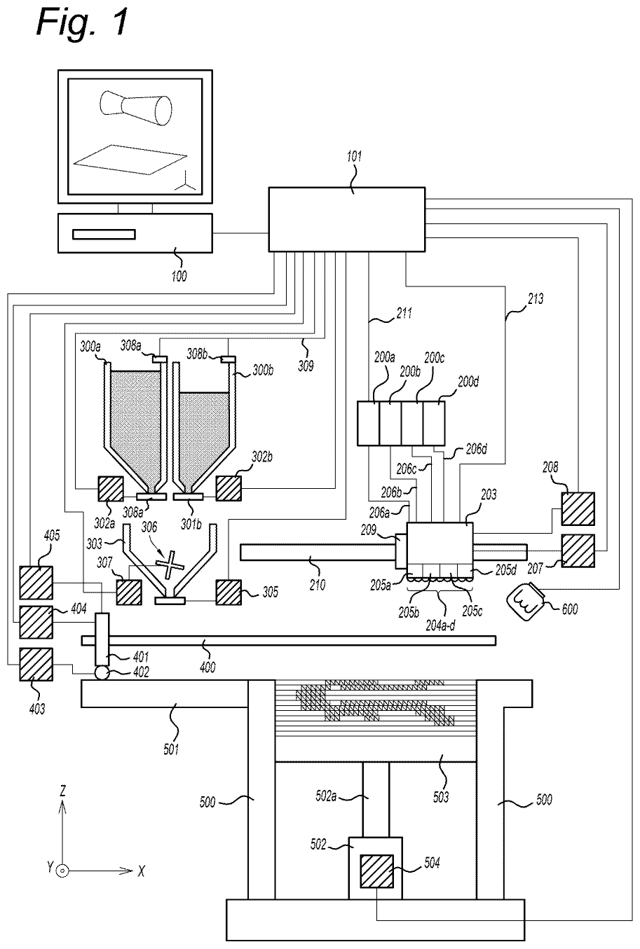

FIG. 1 Schematic of a layer manufacturing system for food fabrication showing the printing apparatus, food material supplying apparatus, food material distributing apparatus and food product forming apparatus.

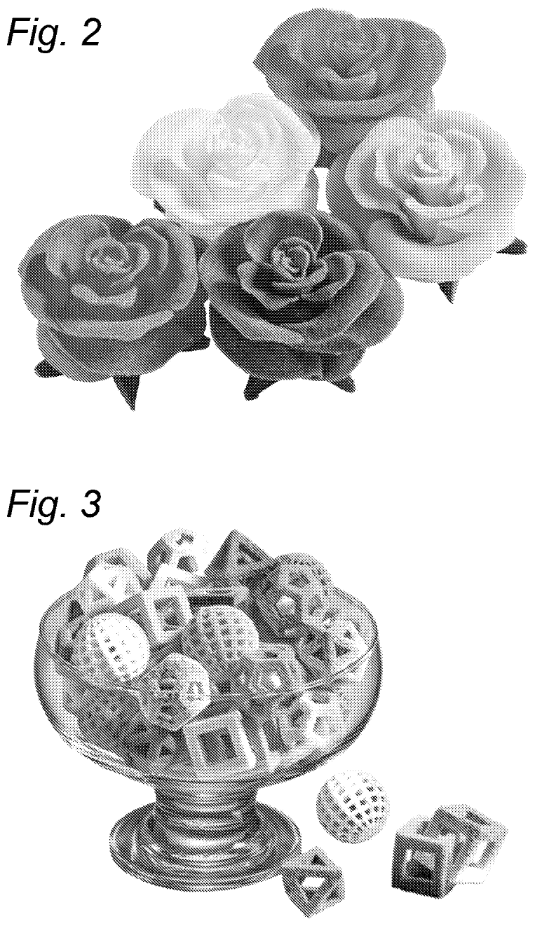

FIG. 2 Image of a three-dimensional sugar-based food product that was produced in accordance with the present invention.

FIG. 3 Image of another three-dimensional sugar-based food product (s) that was produced in accordance with the present invention.

### DETAILED DESCRIPTION OF THE INVENTION

Accordingly, a first aspect of the invention relates to an aqueous binder liquid for use in the layer-by-layer production of 3-D sugar-based food products, said aqueous binder liquid containing:
(a) 50-70 wt. % water;
(b) 12-30 wt. % sugar alcohol;
(c) 5-20 wt. % short chain polyol selected from glycerol, propane-1,2-diol and combinations thereof; and
(d) 3-10 wt. % ethanol;
   wherein components (a), (b), (c) and (d) together constitute at least 90 wt. % of the aqueous binder liquid.

The term “sugar” as used herein, unless indicated otherwise, refers to monosaccharides, disaccharides and combinations thereof. Examples of monosaccharides include fructose and glucose. Sucrose, maltose and lactose are examples of disaccharides.

The term ‘sugar alcohol’ as used herein, unless indicated otherwise, refers to polyols that comprise at least 4 carbon atoms and that can be produced by hydrogenation of saccharides, including, for instance, monosaccharides, disaccharides and starch hydrolysates.

The above mentioned components (a), (b), (c) and (d) together preferably constitute at least 95 wt. %, more preferably at least 97 wt. % of the aqueous binder liquid

The water content of the binder liquid preferably lies in the range of 55-68 wt. %, more preferably in the range of 57-66 wt. %.

The short chain polyol is preferably contained in the binder liquid in a concentration of 7-16 wt. %, more preferably in a concentration of 8-14 wt. %.

The ethanol in the liquid binder has an advantageous effect on surface tension and also provides a preservative effect. The ethanol content of the liquid binder preferably lies in the range of 3.5-8.0 wt. %, more preferably in the range of 4.0-6.0 wt. %.

In order to prevent or slow down microbial spoilage, one or more preservatives may be applied in the binder liquid of the present invention. The binder liquid of the present invention preferably contains 0.01-0.4 wt. %, more preferably 0.02-0.2 wt. % and most preferably 0.03-0.15 wt. % of a preservative selected from sorbate, propionate, benzoate, sulfite and combinations thereof.

According to a preferred embodiment, the preservative is a sorbate, e.g. sorbic acid, potassium sorbate, sodium sorbate, calcium sorbate or a combination thereof.

Microbial spoilage of the liquid binder may also be prevented or slowed down by acidification. Preferably, the liquid binder has a pH in the range of 2.5-4.5. More preferably, the binder liquid has a pH in the range of 2.8-4.0. Most preferably, the pH is in the range of 3.0-3.7.

To achieve an acid pH, an acidulant may be incorporated in the binder liquid. Preferably, the binder liquid contains 0.03-1.0 wt. %, more preferably 0.05-0.5 wt. % and most preferably 0.07-0.3 wt. % of an edible acid.

Examples of acids that may be employed in the binder liquid include malic acid, fumaric acid, acetic acid, citric acid, tartaric acid, adipic acid, succinic acid and combinations thereof.

The binder liquid of the present invention can suitably be used to provide color to the 3-D sugar-based food product. Preferably, the binder liquid is colored red, yellow or blue. These colored binder liquids can suitably be used in combination with a non-colored binder liquid to prepare multi-colored food products from white sugar-containing powders.

Alternate coloring systems based on binder liquids colored cyan, magenta, yellow and optionally black, may also suitably be used to prepare multi-colored food products in accordance with the present invention.

The binder liquid may suitably be colored by incorporating an edible colorant. Preferably, the binder liquid contains at least 1-50 mg/L of edible colorant, more preferably 3-30 mg/L of an edible colorant and most preferably 5-20 mg/L of an edible colorant.

Preferably, the edible colorant that is applied in the binder liquid is a red colorant, a yellow colorant, a blue colorant or a black colorant.

Examples of red edible colorants that may be employed in the binder liquid include FD&C Red 40 (Allura Red AC, E number E129), FD&C Red 2 (Erythrosine, E number E 127), FD&C Red 2 (Amaranth, E number E123), Brilliant Scarlet 4R (Cochineal Red A, E number E124) and Natural Red 4 (carminic acid, E number E120).

Examples of yellow edible colorants that may be employed in the binder liquid are FD&C Yellow 5 (tartrazine, E number 102) and FD&C Yellow 6 (Sunset Yellow, azo type, E number 110).

Examples of blue edible colorants that may be employed in the binder liquid include FD&C Blue No. 1 (Brilliant Blue FCF, E number E133) and FD&C Blue #2 (indigo carmine, E number E132).

Edible black colorants that maybe employed include Black PN (Brilliant Black BR, E number E151) and Vegetable carbon (E number E153).

Alternatively, the edible colorant that is applied in the binder liquid is a cyan colorant, a magenta colorant, a yellow colorant or a black colorant.

Both artificial and natural colorants may be used to impart color to the binder liquid of the present invention.

According to another embodiment, the binder liquid contains a food grade fluorescent dye

Surface tension of the aqueous binder may be optimized for use in inkjet printers by including an adequate amount of a suitable emulsifier. Also the wetting behavior of the liquid binder can be manipulated in this way. The aqueous binder liquid of the present preferably contains 0.03-0.8 wt. %, more preferably 0.05-0.6 wt. % and most preferably 0.1-0.4 wt. % of an emulsifier having a hydrophilic-lipophilic balance (HLB) of 12.0 or more, preferably of 13.0-17.0.

The emulsifier that can be employed in the aqueous binder liquid is preferably selected from polysorbates, polyoxyethylene sorbitan esters, sodium stearoyl-2-lactylate, calcium stearoyl-2-lactate, sucrose fatty acid monoeester, and combinations thereof. More preferably, the emulsifier is a polysorbate. Most preferably, the emulsifier is polysorbate 80.

Flavoring is an example of another component that may suitably be included in the binder liquid of the present invention.

Since, the binder liquid contains ethanol, it may be advantageous to include a denaturant. Rum ether (ethyl oxyhydrate) is an example of a denaturant that may suitably be used.

The binder liquid of the present invention preferably contains no biopolymer such as polysaccharides or proteins, as biopolymers may adversely affect the functioning of print head nozzles.

Sugar alcohol is preferably contained in the binder liquid in a concentration of 15-27 wt. %, more preferably in a concentration of 17-25 wt. %.

The sugar alcohol in the binder liquid has a favorable impact on the rheology of the binder liquid during inkjet spraying. Examples of sugar alcohols that may be included in the aqueous binder liquid include polyglycitol, sorbitol, maltitol, mannitol, erythritol, xylitol, isomalt, lactitol and combinations thereof. Preferably, the sugar alcohol is selected from polyglycitol, sorbitol, maltitol and combinations thereof. Even more preferably, the sugar alcohol is polyglycitol.

Glycerol is preferably applied as the short chain polyol in the binder liquid. Preferably, the binder liquid contains at least 5 wt. % glycerol, more preferably 7-20 wt. % glycerol and most preferably 8-16 wt. % glycerol.

The ethanol content of the binder liquid preferably lies in the range of 4-8 wt. %, more preferably in the range of 4.5-7 wt. %.

The viscosity of the binder liquid preferably is in the range of 1-50 cP, more preferably in the range of 2 to 25 cP and most preferably in the range of 4-10 cP at 73.4 s⁻¹ and a temperature of 86° F. (30° C.).

In another advantageous embodiment, the binder liquid has a surface tension of 25-60 dynes/cm, more preferably of 30-40 dynes/cm and most preferably of 33-38 dynes/cm, at a temperature of 77° F. (25° C.).

In order to ensure optimum jetting performance, dissolved gas levels in the binder liquid should be minimized before the binder liquid enters the inkjet print head. Oxygen gas can suitably be removed from the binder liquid by introducing an oxygen scavenger, such as sulfite, bisulfite or metasulfite salts of alkali metals. Preferably, the binder liquid contains 10-1000 mg/L of oxygen scavenger.

By using two or more binder liquids of different color, color patterns can be introduced during the layer-by-layer production of a 3-D sugar-based food product. By using the three basic colors red, yellow and blue a wide range of color shades can produced. A clear binder liquid may be used to create a white color shade when a white sugar-containing powder used in the preparation of the 3D food product.

Thus, a further aspect of the invention relates to a kit comprising at least four sealed containers including a first container, a second container and a third container, wherein the binder liquid in the first container is colored red, the binder liquid in the second container is colored yellow, the binder liquid in the third container is colored blue and the binder in the fourth container is non-colored.

In an alternative embodiment, the kit comprises at least four sealed containers including a first container, a second container and a third container, wherein the binder liquid in the first container is colored cyan, the binder liquid in the second container is colored magenta, the binder liquid in the third container is colored yellow and the binder in the fourth container is colored black.

Yet another aspect of the invention relates to a three-dimensional sugar-based food product that has been obtained by a method comprising:
(1) depositing a layer of sugar-containing powder;
(2) applying the aqueous binder liquid as defined herein before onto the deposited layer in accordance with a predefined pattern to bond particles contained in the sugar-containing powder;
(3) repeating steps (1) and (2) at least 20 times; and
(4) separating the three-dimensional food product formed by the bonding from non-bonded powder.

The sugar-containing powder applied in the sugar-based food product preferably contains 25-75 wt. % of saccharide selected from monosaccharide, disaccharide and combinations thereof. More preferably, the sugar-containing powder contains at least 25 wt. % of saccharide selected from sucrose, lactose, maltose, fructose, glucose and combinations thereof. Most preferably, the sugar-containing powder contains at least 25 wt. % of sucrose.

Beside sugar, the sugar-containing powder may advantageously contain 25-75 wt. % of modified starch, especially maltodextrin.

In a particularly preferred embodiment, the combination of sugar and modified starch constitutes at least 80 wt. %, more preferably at least 90 wt. % of the sugar-containing powder.

In a preferred embodiment, the three dimensional sugar-based food product shows a color pattern that is defined by the presence at least three different edible colorants, more preferably by the presence of a red colorant, a yellow colorant and a blue colorant.

Alternatively, the three dimensional sugar-based food product shows a color pattern that is defined by the presence of a cyan colorant, a magenta colorant and a yellow colorant.

The 3-D sugar-based product of the present invention typically has a weight in the range of 10-2,000 grams, more preferably a weight of 20-1,000 grams and most preferably a weight of 30-500 grams.

The 3-D sugar-based product of the present invention can suitably be produced using the 3-D printing device described below.

The system comprises a computer 100 and a 3-D food product forming apparatus. The computer 100 is a general desktop type computer or the like that is constructed to include a CPU, RAM, and others. The computer 100 is electronically connected to controlling part 101.

The 3-D food product forming apparatus comprises a controlling part 101, a printing apparatus 200-213, a food material supplying apparatus 300-309, a food material distributing apparatus 400-405, a food product forming apparatus 500-504 and a curing part 600. Each of these parts is electrically connected to the controlling part 101.

The printing apparatus 200-213 includes a driving part 207 for moving the carriage part 203 along the Y-direction guiding part 209, and a driving part 208 for moving said carriage part 203 along the X-direction guiding part 210. Together these parts 207-210 allow the carriage part 203 to move in a plane defined by the X-axis and the Y-axis, as dictated by the controlling part 101, such that it may reach any location within said plane (FIG. 1).

The carriage part 203 contains binder ejector parts 204a-d, connected to binder cartridge parts 205a-d, each of which contains aqueous binder liquid. The binder cartridge parts 205a-d are connected by hose parts 206a-d to the binder storage parts 200a-d, that contain surplus binder liquids.

Each of the binder ejector parts 204a-d is connected to the controller 101 by an ejector connecting part 213. Each of the binder storage parts 200a-d contains a sensor part 212a-d that is connected to the controlling part 101 by a sensor connecting part 211.

The cartridge parts 205a-d and their associated ejector parts 204a-d are components of the carriage part 203, and are therefore freely movable in the XY-plane. The independent ejection behavior of each of the ejector parts 204a-d is individually controlled by the controlling part 101. Binding liquids ejected from the ejector parts 204a-d adhere to the specified region(s) of the current printing stratum (FIG. 1).

While this embodiment contains four binding liquids, (e.g. a red binding liquid, a blue binding liquid, a yellow binding liquid and a clear binding liquid), other embodiments may include any number of binder liquids, which would modify the number of sets of associated components in kind.

The food material supplying apparatus 300-309 includes one or more food material storage parts 300a-b that store food material(s), e.g. confectioners' sugar and maltodextrin. Although two are depicted, there may be any number of food material storage parts 300. The food material(s) stored within these food material storage parts 300 serve as the printing substrate that receive ejected liquid binder (FIG. 1).

Sensor parts 308a-b are connected to the controlling part 101 by a sensor connecting part 309. The sensor parts 308a-b convey the quantity of remaining food material contained in each food material storage part 300 to the controlling part 101.

The shutting parts 301a-b are operated by driving parts 302a-b that are electrically connected to the controlling part 101.

The mixing area part 303 contains a mixing part 306 that is operated by a driving part 307, which is electrically connected to the controlling part 101. A shutting part 304 is operated by a driving part 305 that is electrically connected to the controlling part 101.

The food material distributing apparatus 400-405 includes a distributing part 402 that has a Y-direction dimension at least as great as the Y-direction dimension of the food product containing part 500. The distributing part 402 is attached to a holding part 401 and an associated guiding part 400 that is oriented along the X-axis (FIG. 1).

The X-direction driving part 404 and the Z-direction driving part 405 drive the holding part 401 along the X- and Z-axes, respectively. The holding part 401 is connected to the distributing part 402, which is driven by a driving part 403. Driving parts 403, 404 and 405 are electrically connected to the controlling part 101.

The food product forming apparatus 500-504 comprises a food product containing part 500, a food material holding part 501, a Z-direction moving part 502, a driving part 504 and a plate part 503 (FIG. 1).

The food material holding part 501 is attached to the food product containing part 500, which exhibits a rectangular profile in a XY-cross-section and is characterized by a recessed center. The plate part 503 is located within the recessed center of the food product containing part 500, and the side surfaces of the former are in contact with the vertical inner wall of the latter. The plate part 503 is attached to a supporting part 502a that is driven along the Z-axis by a Z-direction moving part 502. The Z-direction moving part 502 is operated by a driving part 504 that is electrically connected to the controlling part 101. The three-dimensional space that is defined by the plate part 503 and the vertical inner walls of the food product containing part 500 constitutes the area for forming a 3-D food product.

A curing part 600 is electronically connected to the controlling part 101 and may emit heat or other similar curing energy.

The invention is further illustrated by the following non-limiting examples.

### EXAMPLES

### Example 1

A multi-colored food article was printed using a sugar-containing powder and differently colored binder liquids as described below.

Four aqueous binder liquids were prepared on the basis of the recipes that are shown in Table 1. The physical properties of the binding liquid are also shown.

TABLE 1

| | Wt. % | | | |
|---|---|---|---|---|
| Components | Blue | Red | Yellow | Clear |
| FD&C Blue#1 | 1.00 | | | |
| FD&C Red#40 | | 1.00 | | |
| FD&C Yellow#5 | | | 1.00 | |
| Polysorbate 80 | 0.20 | 0.20 | 0.20 | 0.20 |
| Glycerol | 10.00 | 10.00 | 10.00 | 10.00 |
| Polyglycitol | 20.41 | 20.41 | 20.41 | 21.24 |
| Potassium Sorbate | 0.05 | 0.05 | 0.05 | 0.05 |
| Ethanol | 5.40 | 5.40 | 5.40 | 5.40 |
| Malic Acid | 0.11 | 0.11 | 0.11 | 0.11 |
| Rum Ether | 0.30 | 0.30 | 0.30 | 0.30 |
| DI Water | 62.53 | 62.53 | 62.53 | 62.70 |
| pH | 3.4 | 3.4 | 3.5 | 3.2 |
| viscosity @ 30° C. (in cP) | 5.0 | 5.1 | 5.0 | 5.0 |
| Density (g/cm³) | 1.102 | 1.103 | 1.103 | 1.101 |
| Surface Tension (dynes/cm) | 35.8 | 36.2 | 36.1 | 36.3 |

A sugar-containing powder to be used in the 3D printing process was prepared on the basis of the recipe that is shown in Table 2.

TABLE 2

| Components | Wt. % |
|---|---|
| Maltodextrin (DE10) | 49.5 |
| Confectioners' sugar 6X | 49.5 |
| Spray dried almond flavor | 1.0 |

A printed food article was prepared using the above mentioned sugar-containing powder and the above mentioned binder liquids by the 3-D food printing system as described herein before. Further details about the operation of this system can be found in US 2016/0330992.

FIGS. 2 and 3 show images of finished food articles that were produced using the above mentioned device and materials.

1. An aqueous binder liquid for use in layer-by-layer production of three-dimensional sugar-based food products, said aqueous binder liquid containing:
(a) 50-70 wt. % water;
(b) 12-30 wt. % sugar alcohol;
(c) 5-20 wt. % short chain polyol selected from glycerol, propane-1, 2-diol and combinations thereof; and
(d) 3-10 wt. % ethanol; wherein components (a), (b), (c) and (d) together constitute at least 90 wt. % of the aqueous binder liquid.

2. Aqueous binder liquid according to claim 1, wherein the binder liquid contains 0.01-0.4 wt. % of a preservative selected from sorbate, propionate, benzoate, sulfite and combinations thereof.

3. Aqueous binder liquid according to claim 1, wherein the binder liquid has a pH in the range of 2.5-4.5.

4. Aqueous binder liquid according to claim 1, wherein the binder liquid is colored red, yellow, blue.

5. Aqueous binder liquid according to claim 1, wherein the binder liquid contains 0.03-0.8 wt. % of an emulsifier having a hydrophilic-lipophilic balance (HLB) of 12.0 or more.

6. Aqueous binder liquid according to claim 1, wherein the emulsifier is selected from polysorbates, polyoxyethylene sorbitan esters, sodium stearoyl-2-lactylate, calcium stearoyl-2-lactate, sucrose fatty acid monoester and combinations thereof.

7. Aqueous binder liquid according to claim 1, wherein the sugar alcohol is selected from polyglycitol, sorbitol, maltitol, mannitol, erythritol, xylitol, isomalt, lactitol and combinations thereof.

8. Aqueous binder liquid according to claim 7, wherein the sugar alcohol is polyglycitol.

9. Aqueous binder liquid according to claim 1, wherein the binder liquid contains at least 5 wt. % glycerol.

10. Aqueous binder liquid according to claim 1, wherein the binder liquid has a viscosity of 1-50 cP at 73.4 s⁻¹ and a temperature of 86° F.

11. Aqueous binder liquid according to claim 1, wherein the binder liquid has a surface tension of 25-60 dynes/cm at a temperature of 77° F.

12. Aqueous binder liquid according to claim 1, wherein the binder liquid contains added flavoring.

13. A kit comprising at least three sealed containers including a first container, a second container and a third container, each of said first, second and third container holding an aqueous binder liquid according to claim 4, wherein the binder liquid in the first container is colored red, the binder liquid in the second container is colored yellow, and the binder liquid in the third container is colored blue.

14. A three-dimensional sugar-based food product that has been obtained by a method comprising:
(1) depositing a layer of sugar-containing powder;
(2) applying the aqueous binder liquid according to claim 1 onto the deposited layer in accordance with a predefined pattern to bond particles contained in the sugar-containing powder;
(3) repeating steps (1) and (2) at least 20 times; and
(4) separating the three-dimensional food product formed by the bonding from non-bonded powder.

15. Three-dimensional sugar-based food product according to claim 14, wherein the sugar-containing powder contains 25-75 wt. % of saccharide selected from monosaccharide, disaccharide and combinations thereof.

16. Three-dimensional sugar-based food product according to claim 14, wherein the sugar-containing powder contains 25-75 wt. % of modified starch.

17. Three dimensional sugar-based food product according to claim 14, wherein the three-dimensional food product shows a color pattern that is defined by the presence at least three different edible colorants.
